(19) United States
(12) Patent Application Publication
(10) Pub. No.: US 2024/0202704 A1
(43) Pub. Date: Jun. 20, 2024

(54) BLOCKCHAIN-BASED MOBILE ELECTRONIC WALLET SYSTEM

(71) Applicant: NSLAB CO., LTD, Gumi-si (KR)

(72) Inventors: Dong Seong KIM, Gumi-si (KR); Jae Min LEE, Suwon-si (KR); Igboanusi Ikechi SAVIOUR, Gumi-si (KR)

(21) Appl. No.: 18/287,182

(22) PCT Filed: Nov. 2, 2021
(86) PCT No.: PCT/KR2021/015676

§ 371 Date: Oct. 17, 2023

(30) Foreign Application Priority Data
Sep. 17, 2021 (KR) 10-2021-0124951

(51) Int. Cl. G06Q 20/36; G06Q 20/38

(52) U.S. Cl. CPC G06Q 20/3672; G06Q 20/389

(57) ABSTRACT

A method for operating a blockchain-based mobile electronic wallet comprises the steps of: transmitting, by a sender device, via an internet network, a coin from an encrypted coin account of a sender to a token manager of a management device; transmitting, by the token manager, via the internet network, a token to the sender device, once a mining process has been performed in the management device; transmitting, via a near-field communication network, the token from the sender device to a receiver device; and, after the receiver device transmits the token to the token manager via the internet network and performs the mining process, transmitting the coin to an encrypted coin account of a receiver.

### TECHNICAL FIELD

The present invention relates to a mobile electronic wallet, and more specifically, to a blockchain-based mobile electronic wallet system that can be used in an offline environment.

### BACKGROUND ART

The concept of blockchain was invented to remove restrictions on financial transactions by financial institutions. This blockchain paradigm is particularly widely used for financial transactions, but is also gaining popularity for non-financial purposes, where it is widely used in wireless networks. Cryptocurrency emerged to create a decentralized banking system where no financial institution controls the money. Cryptocurrency is a type of virtual currency that uses encryption to secure transactions. Before the introduction of cryptocurrencies, two factors such as financial institutions and internet connectivity determined the success of electronic transactions. The role of financial institutions is weakening with the introduction of crypto payments such as Bitcoin and Ethereum. However, the need for an immediate and continuous connection to the Internet to enable blockchain transactions is still a limitation of the current architecture. Conventional blockchain methods require an Internet connection at the moment of transaction, which limits global adoption.

FIG. 1 is a view showing the conventional blockchain structure.

In the conventional method, the conversion process of the token manager is possible only when there is an Internet connection between the sender (payer) and the receiver (payee). Token manager exists within the network. All transactions through the token manager are incomplete until the receiver provides the remaining information about the transaction or the time limit is reached.

In other words, current blockchain requires continuity of Internet connection, which limits its use, especially in remote areas such as rural areas. Since the current blockchain method requires a continuous Internet connection during the transaction, there is a problem that cryptocurrency transactions are not suitable for rural areas, airplanes (during flight), and sudden disconnection of the Internet provider.

### DISCLOSURE

### Technical Problem

The present invention was proposed to solve the above technical challenges and provides a blockchain-based mobile electronic wallet system that can be used in an offline environment by enabling transactions even if there is a temporary absence of internet connection.

### Technical Solution

According to an embodiment of the present invention to address the above issues, provided is a blockchain-based mobile electronic wallet operation method, the method comprising transmitting, by a sender, a coin from an encrypted coin account of a sender to a token manager of a management device via an internet network, performing a mining process in the management device and then transmitting, by the token manager, via the internet network, a token to the sender device, transmitting the token from the sender device to a receiver device via a short-range wireless communication network, and transmitting, by the receiver device, the token to the token manager via the internet network and performing the mining process, and then transmitting the coin to an encrypted coin account of a receiver.

Further, in the present invention, the near-field communication network is any one of NFC, Wi-Fi, Zigbee, and Bluetooth

Further, in the present invention, the receiver device is given a predetermined first time (Tr) to claim the value of the token, and if the sender device does not transmit the token within the predetermined second time (Ts), after a predetermined third time (Tt), an unclaimed coin is returned to the encrypted coin account of the sender.

Further, in the present invention, the token manager completes all transactions related to the tokens created during one coin-token conversion, and then returns the balance of unused tokens to the encrypted coin account of the sender.

### Advantageous Effects

The blockchain-based mobile electronic wallet system according to an embodiment of the present invention enables transactions even if there is a temporary absence of internet connection, which can overcome the limitations of use in offline environments, such as on airplanes and in remote areas such as rural areas.

### DESCRIPTION OF DRAWINGS

FIG. 1 is a view showing the conventional blockchain structure.

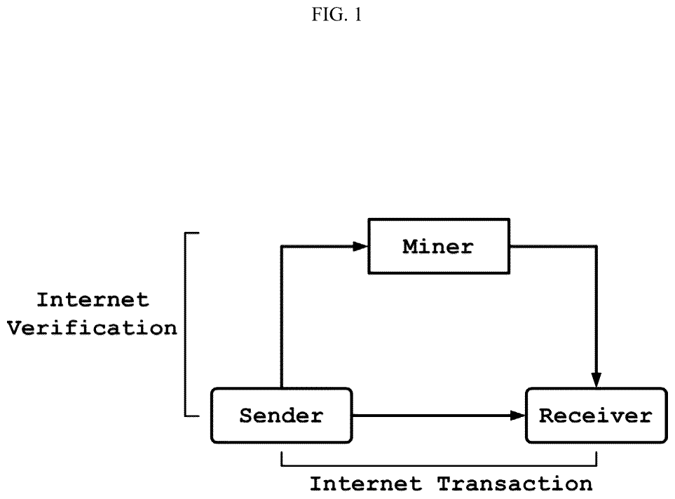

FIG. 2 is a block diagram of the pure wallet blockchain architecture according to an embodiment of the present invention.

FIG. 3 is a view showing the transaction process in which the payer and payee withdraw and deposit money from a bank account.

FIG. 4 is a view showing the proposed pure wallet blockchain architecture illustrating the payment process from payer to payee using tokens via NFC connection.

FIG. 5 is a view showing the interaction process between the sender and receiver in the pure wallet transaction during NFC token exchange.

FIG. 6 is a view showing the pure wallet transaction process proposed in FIG. 2.

### MODE FOR INVENTION

Hereinafter, in order to explain in detail enough to enable a person skilled in the art of the present invention to easily implement the technical idea of the present invention, embodiments of the present invention are described with reference to the accompanying drawings.

The present invention proposes a blockchain-based mobile electronic wallet system using a smartphone-based Pure wallet to conceptually expand blockchain virtual currency for offline transactions.

To briefly summarize, the proposed pure wallet consists of three steps.

First, it requires an Internet connection between the sender (payer) and the token manager to convert crypto coins into offline shared tokens.

Second, tokens are transacted from the sender device to another offline receiver device using short-range wireless communication rather than an Internet connection.

In the third step, the receiver converts the token to the current Internet cryptocurrency (coin) by transmitting the required information to the token manager over the Internet to complete the transaction. This method can be applied not only to finance but also to various IoT technologies. In other words, the present invention relates to expanding the concept of blockchain use in offline situations, and the use of blockchain provides opportunities for banking even to unbanked people.

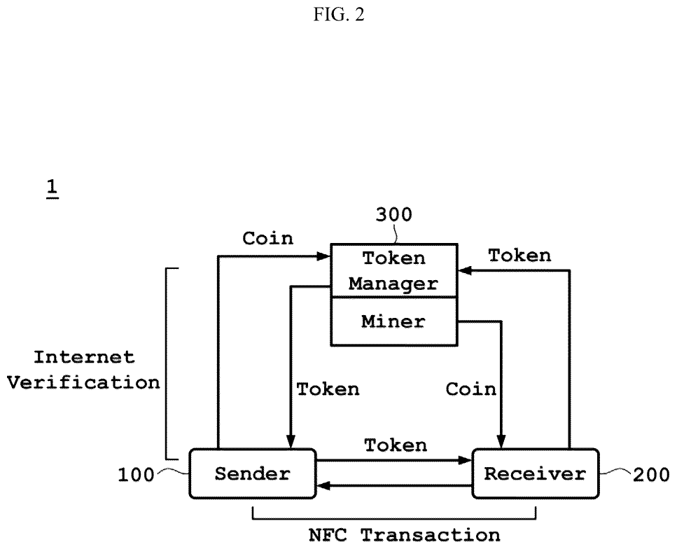

FIG. 2 is a block diagram of the pure wallet blockchain architecture according to an embodiment of the present invention.

Referring to FIG. 2, the blockchain-based mobile electronic wallet system 1 is comprised of a sender device 100, a receiver device 200, and a management device 300 including a token manager module and a miner module.

For reference, in the present invention, for convenience of explanation, the sender device 100 is described interchangeably with the sender (payer), the receiver device 200 is described interchangeably with the receiver (payee), the token manager module is described interchangeably with token manager, and the miner module is interchangeably described with miner.

Further, the sender device 100 and the receiver device 200 are a general term for devices equipped with short-range wireless communication modules such as Bluetooth, Wi-Fi, NFC, and ZigBee, including cell phones, smartphones, smart pads, payment terminals, etc. to allow data to be exchanged wirelessly between devices, thereby enabling users to use the devices for financial transactions.

Further, the management device 300, which includes a token manager module and a miner module, is defined as a general term for the cloud, management server, and management computer that creates and manages blocks recording transaction details of cryptocurrency.

FIG. 2 shows the configuration of a blockchain-based mobile electronic wallet system including the proposed pure wallet blockchain architecture including the conversion process from crypto coins to electronic tokens from the sender (payer) 100 account and the conversion process from receiver (payee) 200 to vice versa.

This conversion process in the token manager can only be performed when connected to the internet, and the token manager resides on the network. All transactions through the token manager have been initiated, but marked on the network as a transaction that has not yet been completed.

The transaction of the proposed pure wallet consists of the following three steps.

First, the sender (payer) 100 converts the coins into tokens of the token manager of the management device 300, and this process requires an Internet connection.

Next, the token information is encrypted by the sender (payer) 100 and transmitted to the receiver (payee) 200. This process does not require an Internet connection. This process is performed through short-range communication such as Bluetooth, Wi-Fi, or NFC. This embodiment describes an example in which a token is transmitted from a sender to a receiver through near field communication (NFC).

Finally, via the Internet, the token of the recipient (payee) 200 is delivered to the token manager, and in response, the correct coin value is transmitted from the token manager to the account of the recipient (payee) 200.

<Algorithm 1: Pure Wallet (PW) processes>

| | |
|---|---|
| 1: | Sender sends coin to token manager via Internet access |
| 2: | Sender receives token via internet access |
| 3: | Transaction is performed offline |
| 4: | Receiver initiates handshake |
| 5: | Receiver sends acknowledgement and approval |
| 6: | Receiver pulls token from sender |
| 7: | Sender confirms value |
| 8: | Sender transfer token |
| 9: | Receiver confirms value and authority of token |
| 10: | Receiver removes token duplicate sent from the sender's account |
| 11: | Receiver confirms receipt and transaction end |
| 12: | End |
| 13: | Receiver sends token to token manager |
| 14: | Token manager transfers transaction to miner for mining |
| 15: | Receiver receives coin |

The proposed pure wallet algorithm is shown in <Algorithm 1>.

The token is transmitted from the sender device 100 within a specific time Ts and is valid for only one transaction.

Tokens received on the receiver device 200 can only be sent to the token manager, meaning that the receiver cannot send tokens to a new account.

At this time, time Tr is provided for the receiver to claim the value of the received token.

If the sender device does not perform any transaction before Ts, it must wait for Tt before the token is converted back to a crypto coin. After Tt, unclaimed coins are returned to the sender's account.

$$Ts + Tr \leq Tt \qquad [ Equation 1 ]$$

The token manager holds all tokens submitted by all receivers until time Tt.

The token manager returns the balance of unused tokens to the coin account of the sender (payer) 100 after completing all transactions related to the tokens created during one coin-token conversion. This is to prevent the possibility of double repayment by the receiver.

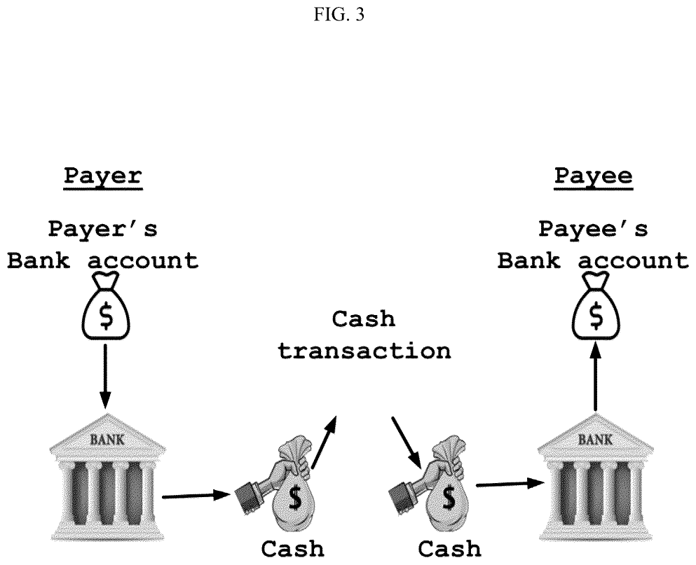

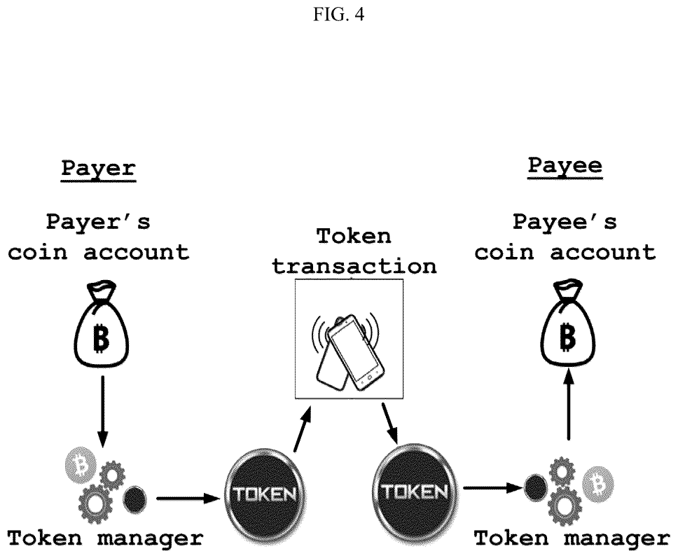

FIG. 3 is a view showing the transaction process in which the payer and payee withdraw and deposit money from a bank account, and FIG. 4 is a view showing a proposed pure wallet blockchain architecture illustrating the payment process from the payer to the payee using a token via NFC connection.

*The process of using cash for transactions is the traditional means shown in FIG. 3. Before the transaction is established, the payer withdraws cash from the bank account. During the transaction, cash is transferred in exchange for goods or services.

The cash is taken to the bank and deposited into the payee's account. A similar process is mimicked in pure wallet for offline transactions, but tokens are used instead of physical cash. The pure wallet process is shown in FIG. 4 and shows similarities to cash transactions as shown in FIG. 3.

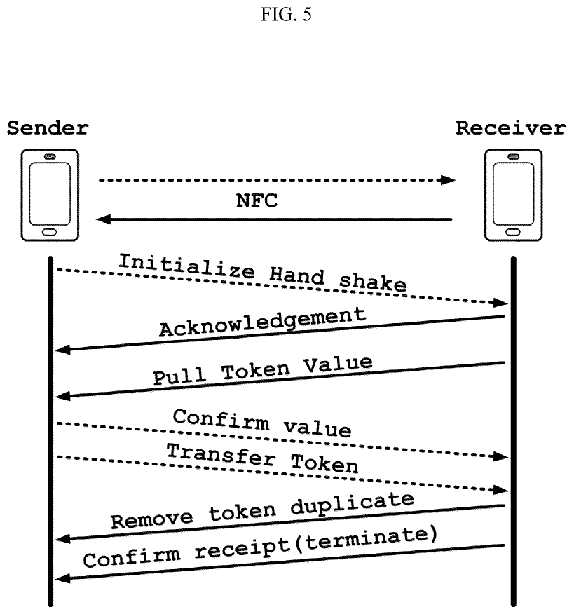

FIG. 5 is a view showing the interaction process between the sender and receiver in the pure wallet transaction during NFC token exchange.

The process is initiated by the sender (payer) 100 and terminated by the receiver (payee) 200. Authorization and encryption are for security between the sender (payer) 100 and the receiver (payee) 200.

To transmit a token without an Internet connection, there must be short-range communication between the receiver (payee) 200 and the sender.

It is important that these token transfers are conducted under secure conditions to prevent cyber-attacks. Near field communication (NFC) may be used for these secure conditions.

NFC is a short-range (about 4 cm) wireless technology that generally consists of two portable devices connected in a peer-to-peer configuration, as shown in FIG. 5. NFC connections using higher layer encryption protocols such as secure socket layer (SSL) are secure from eavesdropping.

NFC secure element (SE) for mobile devices can provide secure on demand access by leveraging short-range wireless communication-based host card emulation (HCE) function.

The token is generated by a cloud-based trusted certification authority (TCA) and stored in the device's tamper-resistant NFC secure element (SE) and trusted platform module (TPM)-based authentication module.

Tokens are used for transactions between NFC devices even if not connected to the Internet, as shown in FIG. 5. The NFC process is initiated with a handshake by the sender (payer) 100.

Acknowledgment (confirmation of receipt) is used to show the profile of the receiver (payee) 200 and confirm that the token was sent to the correct device.

The receiver (payee) 200 device pulls the token value to be transmitted, and the sender device transmits the token after confirming the transmission value.

The receiver (payee) 200 device removes the used token from the sender (payer) 100 device and terminates the transaction. Removal of used tokens is the first preventive measure to prevent double spending.

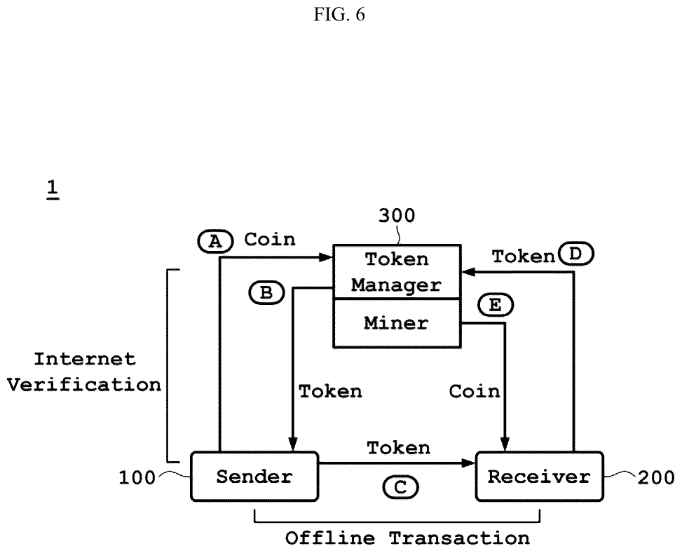

FIG. 6 is a view showing the pure wallet transaction process proposed in FIG. 2.

The proposed Pure wallet transaction is performed through three main steps.

In the first step, the sender (payer, 100) converts some coins into tokens in the token manager (TM). These processes A and B require an internet connection. The pseudocode for this process is shown in Algorithm 2.

<Algorithm 2: Sender to the token manager>

1: Sender sends coin to token manager
2: Mining process
3: Token manager sends token to sender
4: Token manager initiates new transaction

The final step is indicated by D and E in FIG. 6, and in this step, the token in the receiver (payee) 200 device is transmitted to the token manager (TM) of the management device (300) via the Internet, and in response, the token manager (TM) transmits the appropriate coin value to the account of the receiver (payee) 200. The pseudocode for this process is shown in Algorithm 3.

<Algorithm 3: Receiver from the token manager>

1: Receiver sends token to token manager
2: Token manager completes pending transaction
3: Mining process
4: Token manager sends coin value to receiver

Smart contract (SC) is not listed as one of the steps, but they play an important role in the transaction process. The smart contract (SC) is a transaction code that executes a series of commands according to the terms of the contract. The smart contract (SC) resides on the ledger of the blockchain network.

Whenever a transaction is made between the sender (payer) 100 and the token manager (TM), another transfer process is initiated in the token manager (TM). The new transfer process can be completed using only the information contained in the token associated with the transaction, and this process is represented by Algorithm 4.

<Algorithm 4: Smart contract process at token manager>

```
  1: Receive coin from sender
  2: Token (T1) is created by combining
  sender's address and transaction hash
information.
  3: Token is sent to sender's device
  4: Token (T1) starts a transaction that requires sending coins
  5: Coin is sent to all addresses providing
  T1 information within time (Tr)
  6: Otherwise, coin value is returned to sender after time (Tt).
  7: Transaction is ended
```

This work includes five implementation codes; code executed on the sender (payer) 100 device, code running by the token manager, code executed on the receiver (payee) 200 device, and code executed on the smart contract (SC), and the code executed by the miner to ensure automatic transaction mining, and they are used to facilitate the desired behavior of architectural units.

In an implementation example, it is assumed that the sender (payer) 100, the receiver (payee) 200, and the token manager all use different accounts on the same device, and there is only one miner in the network. Table 1 shows the specifications of the devices used in the implementation.

TABLE 1

| Item | Specification | |
|---|---|---|
| Computer | Mac Air 2015 | |
| Memory | 4 | Gb ram |
| Storage | 256 | Gb |

| | |
|---|---|
| Processor | 1.6 Ghz dual core Intel core i5 |
| Operating System | Mac OS Sierra |

Tables 2 to 4 are tables showing the progress of the proposed Pure wallet transaction.

An experimental evaluation was conducted to demonstrate the results of the proposed Pure wallet implementation.

In particular, in the embodiment of the present invention, a demonstration was conducted to show the blockchain implementation of the Pure wallet architecture using the smart contract function of the “Ethereum Blockchain”.

The architecture of this embodiment uses tokens as a unit of offline transactions.

The token resides on the sender's or receiver's device and can be transmitted via a short-range connection (e.g., NFC, Bluetooth, Wi-Fi, etc.). In this verification, tokens with a value of 10 are traded.

Table 2 shows a request message requesting 10 token values from the token manager.

TABLE 2
minerl node test.js 79
\hat{ }C
[MacbookAir13:minerl macbookair13$ node test.js
Token in Agreement SC: [ 10 ]
Token in Agreement SC: [ 0 ]
New withdraw token: 10
Send ether to OxcC681612Fed0f9D4513391F23d32DAA15c7f8aAe
Ether 10 sent to 0xcC681612Fedef9D4513391F23d32DAA15c7f8ake

This process uses an internet connection to connect to the blockchain network. The token manager uses the information contained in the token to complete the pending transaction initiated in Algorithm 2, which requires the token's information.

That is, it can be seen that the receiver device 200 requests 10 tokens from the token manager (TM), and the smart contract (SC) token holding amount has changed from 10 (before the transaction) to 0 (after all tokens have been claimed).

TABLE 3
INFO [04-19|19:56:20.802] Updated mining threads threads=4
INFO [04-19|19:56:20.802] Transaction pool price threshold updated price=1000000000
INFO [04-19|19:56:20.803] Commit new mining work number=256 sealhash=2011c8ma56572
uncles=0 txs=0 gas=0 fees=0 elapsed=221.084us
INFO [04-19|19:56:20.803] Commit new mining work number=256 sealhash=f3b208.dac117
uncles=0 txs=1 gas=21000 fees=2.1e−05 elapsed=942.724us
INFO [04-19|19:56:20.983] Successfully sealed new block number=256
sealhash=f3b208.dac117 hash=af8df1.883a63 elapsed=179.515ms
INFO [04-19|19:56:20.983] block reached canonical chain number=249 hash=ed01ff.,,633b8d
INFO [04-19|19:56:20.983] mined potential block number=256 hash=af8d1P1.883a63
INFO [04-19|19:56:20.983] Commit new mining work number=257 sealhash=3123c2mc6cca1
uncles=0 txs=0 gas=0 fees=0 elapsed=203.931us
INFO [04-19|19:56:21.004] Successfully sealed new block number=257
sealhash=3123c2...c6ccal hash=b9668d..,587b55 elapsed=20.784ms
INFO [04-19|19:56:21.004] block reached canonical chain number=250 hash=4442b0...b95179
INFO [04-19|19:56:21.004] mined potential block number=257 hash=b9668d...587b55
INFO [04-19|19:56:21.004] Commit new mining work number=258 sealhash=c15b8b...89e22d
uncles=0 txs=0 gas=0 fees=0 elapsed=209.491us

Further, the Token Manager (TM) commits transactions to the blockchain when a miner mines a transaction, as shown in Table 3. It is the same mining operation that processes online blockchain transactions. Account balances in multiple accounts prove the success of the transaction.

TABLE 4

Pending transactions! Mining...
No transactions! Mining stopped.
web3.fromWei(eth.getBalance(eth.accounts[0]))
1150.00260016399999998
[> web3.froMWei(eth.getBalanceteth.accounts[1]))
29.999349
[4> web3.fromWei(eth.getBalance(eth.accounts[2]))
29.998612354
[> web3.fromWei(eth.getBalance(eth.accounts[3]))
9.999438382
>== Pending transactions! Mining...
== No transactions! Mining stopped.
==. Pending transactions! Mining...
== No transactions! Mining stopped.
== No transactions! Mining stopped.
[> web3.fromWei(eth.getBalance(eth.accounts[0]))
1165.00263673299999998
[> web3.fromWei(eth.getBalance(etheaccounts[1]))
19.999328
[> web3.fromWei(eth.getBalance(etheaccounts[2]))
29.998612354
[> web3.fromWei(eth.getBalance(eth.accounts[3]))
19.999422913

Table 4 shows the balances of the miner's account (account[0]), the token manager or bank (account[1]), the sender (account[2]), and the receiver (account[3]). The balance indication set of the first account shown at the top of FIG. 9 is before the request, and the balance displayed at the bottom of the drawing shows the balance after withdrawal.

The balance of account[1] is changed from 29.999 to 19.999, indicating that the withdrawal of 10 tokens representing withdrawal from the token manager (TM) was successfully executed. The account[3] is changed from 9.999 to 19.999, indicating that the money was deposited into the receiver's account.

The blockchain-based mobile electronic wallet system of the embodiment of the present invention is needed to improve the cryptocurrency usage experience in four major areas: real-time transactions, transactions in rural areas, reduction of transaction fees, and Internet blind spots.

### Real-Time Transaction

A typical block transaction takes approximately 10 minutes to be added to the block. The time it takes to complete a transaction may take several days depending on certain reasons. For example, block propagation time, number of miners in the network, transaction fees set by the user, web speed, network spam, etc.

Pure wallet is used, allowing real-time transactions to be successfully performed at any time. NFC wireless communication, operating at a frequency of 13.56 MHz, provides a data rate of 424 kbit/s. A 64-character token encoded in UTF-8, UTF-16, or UTF-32 is delivered as 0.0012 s, 0.0023 s, and 0.0047 s, respectively. After receiving the token from the receiver, the token manager completes the transfer to the crypto coin account of the receiver at time Tt.

### Reduction in Transaction Fee

As the popularity of cryptocurrencies grows, users focus on high-fee transactions, so that it is used by miners who take advantage of excessive waiting time.

Pure wallet allows transactions to proceed at any time regardless of the immediate average transaction fee, and the token manager completes the transfer in one go with a low average transaction fee.

### Transaction in Rural Area

The concept of cryptocurrency is to provide financial services to everyone, including rural areas without banking infrastructure. However, in these rural areas, the possibilities for cryptocurrency trading are very limited due to poor or non-existent internet connectivity.

According to data from the International Telecommunication Union, internet usage was below 15% in some countries in 2017, making cryptocurrency adoption in those regions unlikely. Therefore, the goal of bankless banking will be achieved faster by using the proposed pure wallet.

### Internet Blind Spot

During the flight, passengers can purchase products sold through pure wallet without actual cash. Further, urban areas with poor or no internet connectivity can be considered some of the potential beneficiaries of the proposed blockchain algorithm.

Globally, awareness and adoption of blockchain is increasing, but is still limited to those with an internet connection.

The blockchain-based mobile electronic wallet system according to an embodiment of the present invention introduces a token manager to the blockchain network and applies token and smart contract functions to present a blockchain architecture that enables transactions. In other words, the blockchain aspect of a novel payment technique for cryptocurrency called pure wallet (PW) was explained and implemented. This involves converting cryptocurrencies (coins) into digital tokens used for transactions, in an offline environment.

The Pure wallet architecture was successfully implemented using “Ethereum” supported smart contracts. Although the system according to the embodiment has the limitation of sending tokens in their entirety, offline transactions of 10 tokens were completed, proving that the pure wallet architecture has successfully enabled blockchain for offline transactions.

The blockchain-based mobile electronic wallet system according to an embodiment of the present invention enables transactions even if there is a temporary absence of internet connection, which can overcome the limitations of use in offline environments, such as on airplanes and in remote areas such as rural areas.

As such, those skilled in the art to which the present invention pertains will understand that the present invention can be implemented in other specific forms without changing its technical idea or essential features. Therefore, the embodiments described above should be understood in all respects as illustrative and not restrictive. It should be interpreted that the scope of the present invention is indicated by the claims to be described later rather than the detailed description above, and all changes or modifications derived from the meaning and scope of the claims and equivalent concepts thereof are included in the scope of the present invention.

1. A blockchain-based mobile electronic wallet operation method, the method comprising:
transmitting, by a sender, a coin from an encrypted coin account of a sender to a token manager of a management device via an internet network;
performing a mining process in the management device and then transmitting, by the token manager, via the internet network, a token to the sender device;
transmitting the token from the sender device to a receiver device via a short-range wireless communication network; and
transmitting, by the receiver device, the token to the token manager via the internet network and performing the mining process, and then transmitting the coin to an encrypted coin account of a receiver.

2. The blockchain-based mobile electronic wallet operation method of claim 1,
wherein the near-field communication network is any one of NFC, Wi-Fi, Zigbee, and Bluetooth.

3. The blockchain-based mobile electronic wallet operation method of claim 1,
wherein the receiver device is given a predetermined first time (Tr) to claim the value of the token, and if the sender device does not transmit the token within the predetermined second time (Ts), after a predetermined third time (Tt), an unclaimed coin is returned to the encrypted coin account of the sender.

4. The blockchain-based mobile electronic wallet operation method of claim 1,
wherein the token manager completes all transactions related to the tokens created during one coin-token conversion, and then returns the balance of unused tokens to the encrypted coin account of the sender.

5. A blockchain-based mobile electronic wallet system using the blockchain-based mobile electronic wallet operation method of claim 1.
